(19) United States
(12) Patent Application Publication
(10) Pub. No.: US 2026/0179072 A1
(43) Pub. Date: Jun. 25, 2026

(54) COMMODITY MASTER GENERATION DEVICE AND METHOD

(71) Applicant: Toshiba Tec Kabushiki Kaisha, Tokyo (JP)

(72) Inventor: Takashi KADO, Mishima Shizuoka (JP)

(21) Appl. No.: 19/323,615

(22) Filed: Sep. 9, 2025

(30) Foreign Application Priority Data
Dec. 20, 2024 (JP) 2024-225660

(51) Int. Cl. G06Q 20/20

(52) U.S. Cl. CPC G06Q 20/203; G06Q 20/202

(57) ABSTRACT

According to one embodiment, a commodity master generation device includes a communication interface connectable to a plurality of point-of-sale systems of different stores, a storage unit for storing sales management data from the plurality of point-of-sale systems, and a processor. The processor is configured to acquire sales management data generated by different point-of-sale systems using different commodity masters in which the same commodity code is associated with different feature data, then determine a classification grouping for a commodity code based on similarity of the different feature data to feature data associated with another commodity code associated with the classification grouping. The processor selects category information to be used with a commodity code from predefined category information based on the determined classification grouping and generates a unified commodity master in which the selected category information is used in association with a commodity code.

### CROSS-REFERENCE TO RELATED APPLICATION

This application is based upon and claims the benefit of priority from Japanese Patent Application No. 2024-225660, filed December 20, 2024, the entire contents of which are incorporated herein by reference.

### FIELD

Embodiments described herein relate generally to a commodity master generation device and a method therefor.

### BACKGROUND

There is a service in which a purchaser’s buying behavior is tracked and analyzed across one or more retail stores then utilized for marketing. Data for such a service can be efficiently processed when the data about sold merchandise from each retail store is uniform in format and the like.

Often, a commodity identification code, a so-called global trade item number (GTIN) is set for each merchandise/commodity item in a unified manner regardless of the retail store. However, since retail stores often individually adopt a category identification of each item/commodity in addition to the GTIN, there are many cases where this category identification is not uniform across different retail stores. Therefore, before starting the analysis of data from different stores, it is necessary to check that the data collected from each retail store is uniform/compatible and then perform additional work for unifying category information or the like, and this analysis work on the data cannot be efficiently performed.

### BRIEF DESCRIPTION OF THE DRAWINGS

FIG. 1 is a schematic overview of a system incorporating a commodity master generation device according to an embodiment.

FIG. 2 is a schematic diagram of a POS system.

FIG. 3 is a schematic diagram illustrating a structure of commodity sales data.

FIG. 4 is a schematic diagram illustrating a data structure of a commodity record.

FIG. 5 is a schematic diagram illustrating a structure of sales management data.

FIG. 6 is a block diagram of a commodity generation device according to an embodiment.

FIG. 7 is a schematic diagram illustrating a data structure of a category master.

FIG. 8 is a schematic diagram illustrating a data structure of an integrated master.

FIG. 9 is a schematic diagram illustrating a data structure of a first table.

FIG. 10 is a schematic diagram illustrating a data structure of a second table.

FIG. 11 is a schematic diagram illustrating a data structure of a third table.

FIG. 12 is a schematic diagram illustrating a data structure of a fourth table.

FIG. 13 is a schematic diagram illustrating a data structure of a fifth table.

FIG. 14 is a block diagram illustrating a functional configuration of aspects of a commodity master generation device according to an embodiment.

FIG. 15 is a flowchart of information processing executed by a processor according to a collection program.

FIGS. 16 to 21 are flowcharts of information processing executed according to a generation program.

FIG. 22 is a schematic diagram illustrating an example of data recorded in a first table at a time of ACT25 in FIG. 16.

FIG. 23 is a schematic diagram illustrating an example of data recorded in a second table at a time of ACT39 in FIG. 17.

FIG. 24 is a schematic diagram illustrating an example of data recorded in a third table at a time of ACT59 in FIG. 18.

FIG. 25 is a schematic diagram illustrating an example of data recorded in a second table at a time when "YES" is determined in ACT64 in FIG. 19.

FIG. 26 is a schematic diagram illustrating an example of data recorded in a second table at a time when "YES" is determined in ACT81 in FIG. 17.

FIG. 27 is a schematic diagram illustrating an example of data recorded in a fourth table at a time of ACT83 in FIG. 20.

FIG. 28 is a schematic diagram illustrating an example of data recorded in a fourth table at a time when "YES" is determined in ACT87 in FIG. 20.

FIG. 29 is a schematic diagram illustrating an example of data recorded in a fifth table at a time when "YES" is determined in ACT104 in FIG. 21.

### DETAILED DESCRIPTION

A problem to be solved by an embodiment is to provide a commodity master generation device capable of efficiently generating a commodity master in which information such as an item categorization is unified across the data collected from a plurality of different retail stores.

In general, in one embodiment, a commodity master generation device includes a communication interface connectable to a plurality of point-of-sale systems of different stores, a storage unit for storing sales management data from the plurality of point-of-sale systems, and a processor. The processor is configured to: acquire first sales management data generated by a first point-of-sale system using a first commodity master in which a first commodity code is associated with first feature data and second sales management data generated by a second point-of-sale system using a second commodity master in which the first commodity code is associated with second feature data; determine a classification grouping for the first commodity code based on similarity of the first and second feature data to feature data associated with a second commodity code associated with the classification grouping; select category information to be used with the first commodity code from predefined category information based on the determined classification grouping; and generate a third commodity master in which the selected category information is used in association with the first commodity code.

Hereinafter, certain example embodiments of a commodity master generation device for efficiently generating a commodity master in which information such as category is unified across different retail stores will be described with reference to the drawings.

### Schematic Description of Commodity Master Generation Device

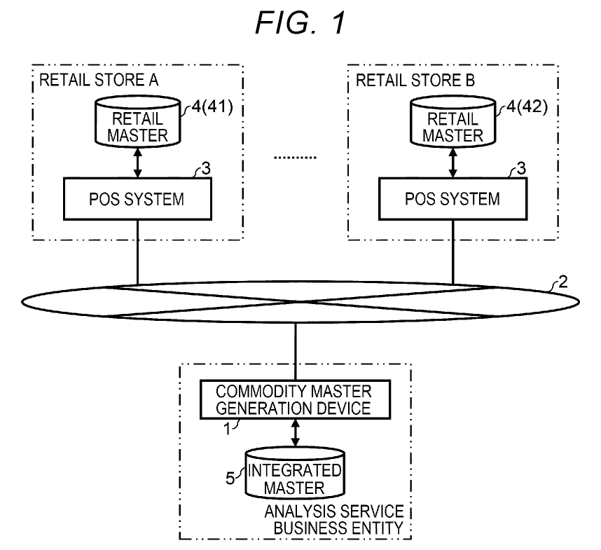

FIG. 1 is a schematic diagram illustrating an outline of a commodity master generation device 1 according to the embodiment. The commodity master generation device 1 is an information processing device managed by an analysis service business entity in charge of collecting and analyzing product sales data and the like from a plurality of retail stores (in FIG. 1, a retail store A, a retail store B, are depicted but the number of stores is not limited to two). In some examples, the commodity master generation device 1 may be an information processing device managed by another business entity that provides an integrated master 5 to the analysis service business entity mentioned above. The commodity master generation device 1 can be connected, via a communication network 2, to different (multiple) point of sales (POS) systems 3 introduced into various retail stores. The communication network 2 can be a wide area network such as the Internet or other network, whether public or private. A mobile communication network, a public communication network, and the like may be used as a part of the communication network 2.

The POS system 3 manages (tracks) sales, inventory, and the like of the entire store in real time and aggregates for every commodity/item a sales quantity, a sales amount, and the like on at least a daily basis for the store. The POS system 3 uses a retail master 4. The retail master 4 is a database that centrally manages information about the various commodities sold in the store. Specifically, the retail master 4 manages information such as a commodity name, a unit price, and a category for each commodity identified by a commodity identification code. Here, the commodity identification code is unified across the retail stores by using, for example, GTIN, but the other information such as commodity name, unit price, and category is not unified across the retail stores because each retail store independently sets such information. Therefore, each retail store has its own store-specific retail master 4. For example, the retail store A includes a retail master 41 that centrally manages information about various commodities sold in the retail store A, and the retail store B includes a retail master 42 that centrally manages information about various commodities sold in the retail store B. The retail master 4 may be referred to as a commodity master. That is, the retail master 41 is an aspect of the first commodity master, and the retail master 42 is an aspect of the second commodity master.

The commodity master generation device 1 generates the integrated master 5. The integrated master 5 is a database that centrally manages information about various commodities sold in all the retail stores. Specifically, the integrated master 5 manages the category information of each commodity identified by a commodity identification code. In some contexts, such an integrated master 5 can also be referred to as a commodity master. That is, the integrated master 5 is an aspect of the third commodity master.

### Description of POS System

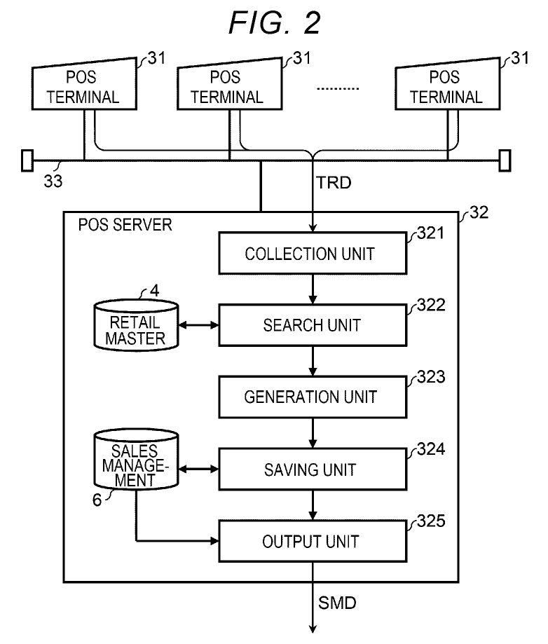

FIG. 2 is a schematic diagram illustrating a schematic configuration of the POS system 3. The POS system 3 includes a plurality of POS terminals 31 and a POS server 32. The POS system 3 connects the plurality of POS terminals 31 and the POS server 32 via a communication network 33. The communication network 33 is, for example, a local area network (LAN). LAN may be a wired LAN or a wireless LAN.

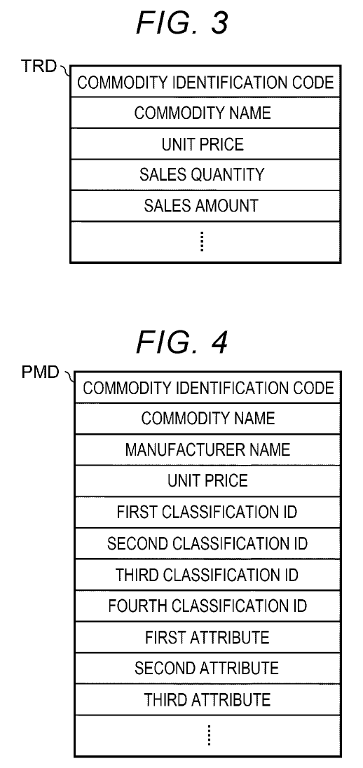

The POS terminal 31 is an electronic device that registers sales data of a commodity purchased by a purchaser. The POS terminal 31 includes, for example, a scanner for reading a barcode, and acquires, from the barcode read by the scanner, a commodity identification code of the commodity purchased by the purchaser. The POS terminal 31 acquires a commodity name, a unit price, and the like of the commodity identified by the commodity identification code from the retail master 4, and registers commodity sales data TRD (see FIG. 3) in a memory. When a price of the commodity purchased by the purchaser is input, the POS terminal 31 settles the transaction with the purchaser. The POS terminal 31 transmits the commodity sales data TRD registered in the transaction to the POS server 32 via the communication network 33.

FIG. 3 is a schematic diagram illustrating a data structure of the commodity sales data TRD. As illustrated, the commodity sales data TRD includes the commodity identification code of the commodity purchased by the purchaser, the commodity name, the unit price, and the sales quantity of the commodity, and the sales amount calculated by multiplying the unit price by the sales quantity. For example, when the purchaser in a sales transaction purchases two of a first commodity (having a unit price of 100 yen and a commodity name of XXX) and one of a second commodity (having a unit price of 200 yen and a commodity name of YYY), the POS terminal 31 transmits first commodity sales data TRD to the POS server 32 including a commodity identification code for the first commodity, the commodity name XXX, the unit price of 100 yen, the sales quantity of 2, and a sales amount of 200 yen and second commodity sales data TRD including a commodity identification code for the second commodity, the commodity name YYY, the unit price of 200 yen, the sales quantity of 1, and a sales amount of 200 yen when settlement of the sales transaction with the purchaser occurs.

Since such a POS terminal 31 is well known, additional description thereof will be omitted here. The POS terminal 31 may be a face-to-face model operated by a store clerk or a self-service model operated by the purchaser.

Referring back to the description of FIG. 2.

The POS server 32 is a computer providing functions of a collection unit 321, a search unit 322, a generation unit 323, a saving unit 324, and an output unit 325. The POS server 32 may be a computer provided on-premises or via a cloud computing environment.

The collection unit 321 has a function of collecting the commodity sales data TRD transmitted from each POS terminal 31. The collection unit 321 provides the commodity sales data TRD collected from each POS terminal 31 to the search unit 322.

The search unit 322 has a function of searching for the retail master 4 based on the commodity sales data TRD provided from the collection unit 321 and acquiring information necessary for sales management. The retail master 4 is an aggregate of commodity records PMD (see FIG. 4) generated for various commodities sold in the retail store.

FIG. 4 is a schematic diagram illustrating a data structure of the commodity record PMD. As illustrated, the commodity record PMD includes items such as a commodity identification code, a commodity name, a manufacturer name, a unit price, a first classification ID, a second classification ID, a third classification ID, a fourth classification ID, a first attribute, a second attribute, and a third attribute.

The first classification ID is an identification code of a category generally referred to as a major classification. The second classification ID is an identification code of a category generally referred to as a medium classification. The third classification ID is an identification code of a category generally referred to as a small classification. The fourth classification ID is an identification code of a category generally referred to as a fine classification. The major classification is the largest category such as food and daily necessities, and is subdivided in the order of the medium classification, the small classification, and the fine classification. Attribute information such as the first attribute, the second attribute, and the third attribute is, for example, information about an attribute of a commodity such as a tax type/category for a consumption (sales) tax, associated sales conditions/restrictions such as an minimum age limit, or a food allergy warning.

The search unit 322 searches the retail master 4 for the commodity identification code of the commodity sales data TRD. Then, the search unit 322 acquires, from the commodity record PMD matching the commodity identification code, the commodity name, the manufacturer name, the unit price, the first classification ID, the second classification ID, the third classification ID, and the fourth classification ID as information necessary for the sales management.

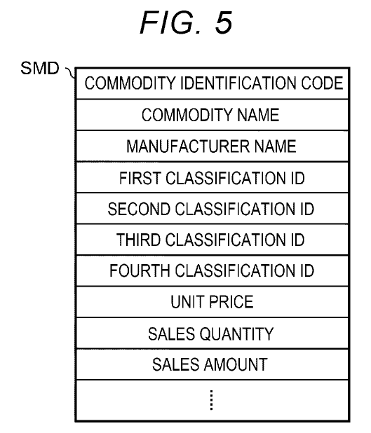

The generation unit 323 has a function of generating sales management data SMD (see FIG. 5) based on the commodity sales data TRD and the information necessary for the sales management acquired by the search unit 322.

FIG. 5 is a schematic diagram illustrating a data structure of the sales management data SMD. As illustrated, the sales management data SMD includes the commodity identification code, the sales quantity, and the sales amount included in the commodity sales data TRD, and the manufacturer name, the unit price, the first classification ID, the second classification ID, the third classification ID, and the fourth classification ID which are information necessary for the sales management.

The saving unit 324 has a function of saving the sales management data SMD (generated by the generation unit 323) in a sales management file 6. With this function, the sales management data SMD (which is generated based on the commodity sales data TRD registered by each POS terminal 31) is sequentially saved in the sales management file 6.

The output unit 325 has a function of outputting the sales management data SMD (saved in the sales management file 6) to the outside. For example, the output unit 325 outputs the sales management data SMD to the commodity master generation device 1 of an analysis service business entity connected to the communication network 2.

### Description of Configuration of Commodity Master Generation Device

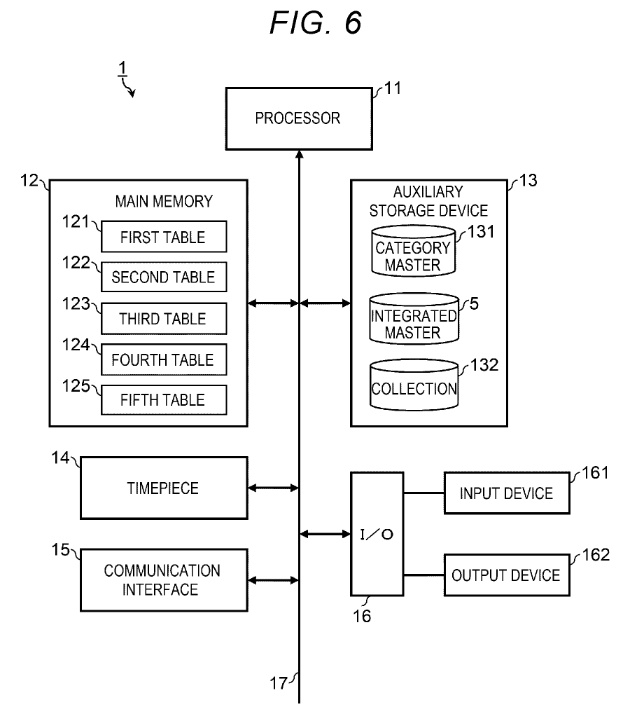

FIG. 6 is a block diagram of the commodity master generation device 1. The commodity master generation device 1 includes circuit components such as a processor 11, a main memory 12, an auxiliary storage device 13, a timepiece 14, a communication interface 15, and an input and output (I/O) interface 16, and a system transmission path 17. The system transmission path 17 includes an address bus, a data bus, a control signal line, and the like.

The processor 11 controls each unit to implement various functions of the commodity master generation device 1 according to an operating system and/or an application program (application software). The processor 11 is, for example, a central processing unit (CPU). The processor 11 may be, for example, a micro processing unit (MPU), a system on a chip (SoC), a digital signal processor (DSP), a graphics processing unit (GPU), an application specific integrated circuit (ASIC), a programmable logic device (PLD), or a field-programmable gate array (FPGA). Alternatively, the processor 11 may be a combination of a plurality of the above components.

The main memory 12 includes a nonvolatile memory area and a volatile memory area. The main memory 12 stores the operating system or the application program in the nonvolatile memory area. The main memory 12 may store data necessary for the processor 11 to execute processing for controlling each unit in the nonvolatile or volatile memory area. The main memory 12 uses the volatile memory area as a work area in which data is appropriately rewritten by the processor 11. The nonvolatile memory area is, for example, a read only memory (ROM). The volatile memory area is, for example, a random access memory (RAM).

The auxiliary storage device 13 may be an electric erasable programmable read-only memory (EEPROM), a hard disc drive (HDD), or a solid-state drive (SSD). The auxiliary storage device 13 saves data used by the processor 11 to perform various types of processing, data generated by processing in the processor 11, and the like. The auxiliary storage device 13 may store the application program.

The timepiece 14 records date and time. The commodity master generation device 1 processes the date and time recorded by the timepiece 14 as current date and time.

The communication interface 15 is connected to the communication network 2. The commodity master generation device 1 can perform data communication with the POS server 32 of each retail store connected to the communication network 2 via the communication interface 15.

The I/O interface 16 is a circuit for transmitting and receiving various data signals to and from an input device 161 and an output device 162. The input device 161 is, for example, a keyboard, a mouse, a touch sensor, or a scanner. The output device 162 is, for example, a display, a printer, or a speaker.

In the commodity master generation device 1, a part of a storage area in the auxiliary storage device 13 may be used for a category master 131, the integrated master 5, and a collection file 132. The collection file 132 is a data file for saving the sales management data SMD collected from the POS server 32 of each retail store.

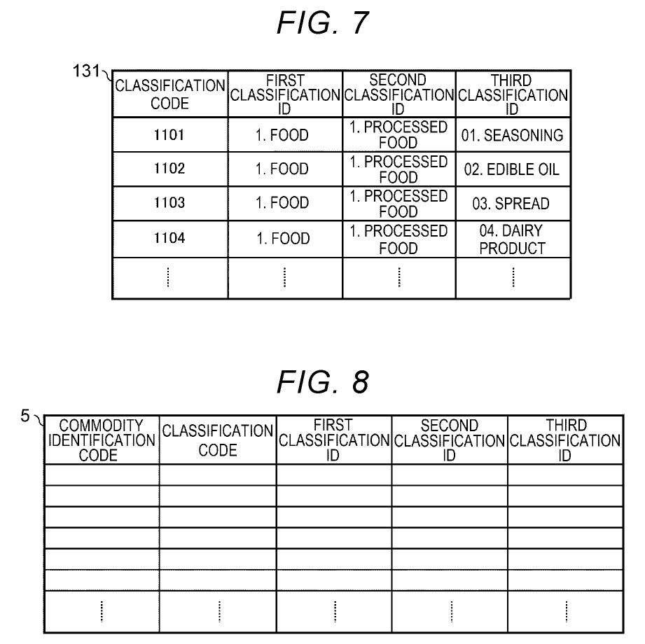

FIG. 7 is a schematic diagram illustrating a data structure of the category master 131. As illustrated in the drawing, the category master 131 is an aggregate of category records including items of a classification code, a first classification ID, a second classification ID, and a third classification ID. The classification code is a code for uniquely identifying a combination of the first classification ID, the second classification ID, and the third classification ID. The first classification ID is an ID uniquely assigned to a category called a major classification, for example, a category such as food or daily necessities. The second classification ID is an ID uniquely assigned to a category called a medium classification, for example, a category such as processed food, fresh food, and confectionery when the major classification is food. The third classification ID is an ID uniquely assigned to a category called a small classification, for example, a category such as a seasoning, an edible oil, a spread, or a dairy product when the medium classification is processed food. Such a category master 131 is generated based on, for example, a classification code managed by JAN item code file service (JICFS) and category information of the major classification, the medium classification, and the small classification identified by the classification code.

FIG. 8 is a schematic diagram illustrating a data structure of the integrated master 5. As illustrated, the integrated master 5 is an aggregate of integrated records including items of a commodity identification code, a classification code, a first classification ID, a second classification ID, and a third classification ID. The commodity master generation device 1 generates the integrated master 5, that is, the third commodity master by registering the integrated record in the integrated master 5.

Referring back to the description of FIG. 6.

In order to generate the integrated master 5, the commodity master generation device 1 uses a part of the volatile memory area in the main memory 12 for a first table 121, a second table 122, a third table 123, a fourth table 124, and a fifth table 125.

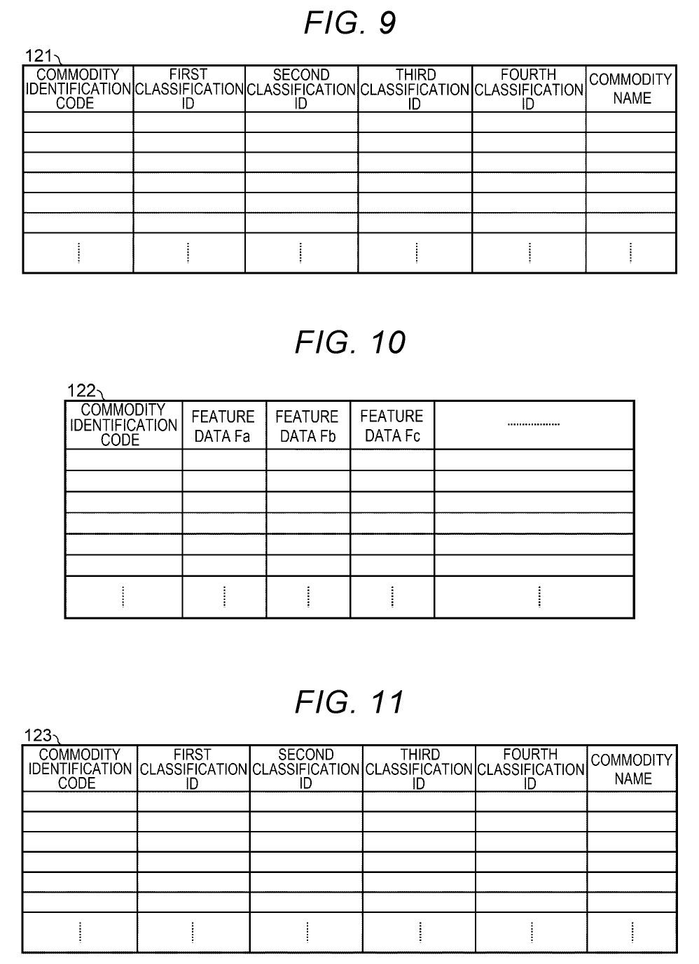

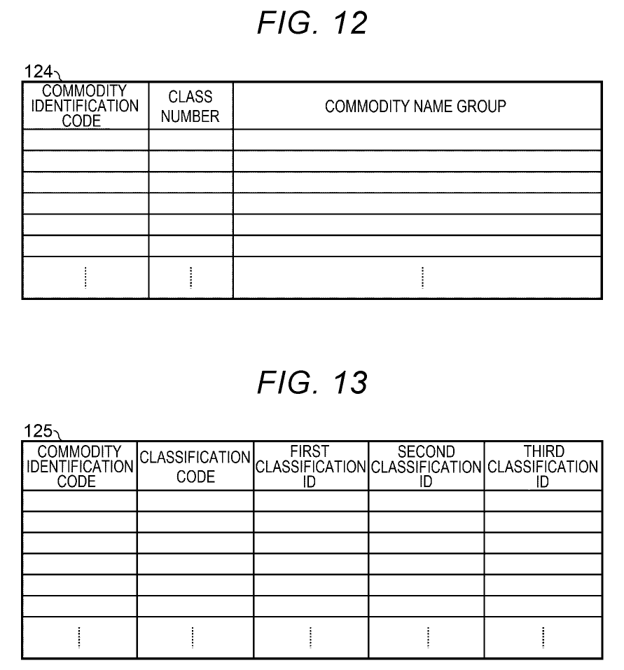

FIGS. 9 to 13 are schematic diagrams illustrating data structures of the first table 121, the second table 122, the third table 123, the fourth table 124, and the fifth table 125, respectively. As illustrated in FIG. 9, the first table 121 includes a commodity identification code column, a first classification ID column, a second classification ID column, a third classification ID column, a fourth classification ID column, and a commodity name column. As illustrated in FIG. 10, the second table 122 includes a commodity identification code column and columns of a plurality of pieces of feature data identification information Fa, Fb, Fc, and the like. As illustrated in FIG. 11, the third table 123 includes a commodity identification code column, a first classification ID column, a second classification ID column, a third classification ID column, a fourth classification ID column, and a commodity name column. As illustrated in FIG. 12, the fourth table 124 includes a commodity identification code column, a class number column, and a commodity name group column. As illustrated in FIG. 13, the fifth table 125 includes a commodity identification code column, a classification code column, a first classification ID column, a second classification ID column, and a third classification ID column.

The data recorded in each of the first table 121, the second table 122, the third table 123, the fourth table 124, and the fifth table 125 will be explained further with description of a generation program below. In the description, it is assumed that the first to fifth tables 121 to 125 have row number values applied as serial numbers starting from 1. These row number values may also be referred to as table numbers.

### Description of Function of Commodity Master Generation Device

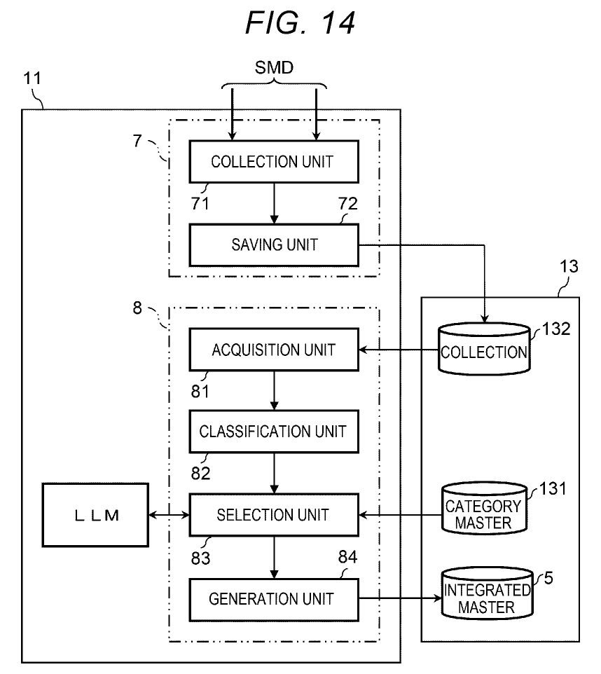

FIG. 14 is a block diagram illustrating a functional configuration of the commodity master generation device 1. The commodity master generation device 1 implements a function as a collection process 7 and a function as a generation process 8 by the operation of the processor 11.

The collection process 7 has a function as a collection unit 71 and a function as a saving unit 72. The collection unit 71 has a function of collecting the sales management data SMD received from the POS system 3 of each retail store. For example, the collection unit 71 collects first sales management data SMD and second sales management data SMD from the POS server 32 of the POS system 3 constructed in a first retail store A using the first commodity master (retail master 41) and the POS server 32 of the POS system 3 constructed in a second retail store using the second commodity master (retail master 42).

The saving unit 72 has a function of saving the sales management data SMD collected by the collection unit 71 in the collection file 132. For example, the saving unit 72 saves, in the collection file 132, the first sales management data SMD collected from the POS server 32 of the POS system 3 constructed in the first retail store A and the second sales management data SMD collected from the POS server 32 of the POS system 3 constructed in the second retail store. Thus, in the collection file 132, the first sales management data SMD and the second sales management data SMD are mixed and saved.

The generation process 8 has functions as an acquisition unit 81, a classification unit 82, a selection unit 83, and a generation unit 84. The acquisition unit 81 has a function of acquiring, from the sales management data SMD saved in the collection file 132, information of a first item that can be feature data in cluster analysis (clustering) for each commodity. That is, the acquisition unit 81 acquires the information of the first item that can be the feature data for each commodity, from the first sales management data SMD generated using the first commodity master (retail master 41) and the second sales management data SMD generated using the second commodity master (retail master 42). The first item is one of the second classification ID, the third classification ID, and the fourth classification ID. In the embodiment, the first item is the fourth classification ID. The first item may be a combination of two or more IDs of the second classification ID, the third classification ID, and the fourth classification ID. Alternatively, a unique code generated by encoding two or more IDs may be used as the first item.

The classification unit 82 has a function of classifying a commodity based on similarity of a first item in its associated information ass acquired by the acquisition unit 81. The classification unit 82 classifies each commodity by, for example, an unsupervised clustering method using first item information as feature data. The classification unit 82 assigns a class number to each classification. Such an unsupervised clustering method may be a non-hierarchical clustering method such as the K-Means method or the Gaussian mixture model (GMM), or may be a hierarchical clustering method such as the WARD method or the Diana method.

The selection unit 83 selects, category information suitable for the commodities belonging to the same classification from predefined category information based a second item information included in the sales management data SMD of commodities recognized to belong to the same classification by the classification unit 82. That is, the selection unit 83 selects (assigns) category information (labels) for the classification code, the first classification ID, the second classification ID, and the third classification ID in the category master 131 based on other information (second item information) included in the sales management data SMD recognized as belonging to the same classification from among the first sales management data SMD generated using a first commodity master (retail master 41) and the second sales management data SMD generated using a second commodity master (retail master 42). In this context, the other information (“a second item”) is, for example, text data indicating a commodity name. Specifically, the selection unit 83 selects a category by a data labeling method executed by a generative AI using a large-scale language model (LLM). That is, the selection unit 83 selects category information (labels) to be used in the category master 131 as an answer from the large-scale language model provided in response to the inputting of the commodity names of other commodities belonging to the same classification. The large-scale language model is a language model constructed based on a large amount of data and deep learning technology such that a type of category can be selected (identified) from input commodity names.

The generation unit 84 has a function of generating a third commodity master in which category information suited to a commodity (more particularly, its unique commodity identification code) is recorded. That is, the generation unit 84 generates the third commodity master (e.g., integrated master 5) by registering the commodity identification code(s) included in the sales management data SMD recognized as belonging to the same classification and the category information for the classification code, the first classification ID, the second classification ID, and the third classification ID as selected by the selection unit 83 as the category information suited to the commodity identified by the commodity identification code.

### Description of Collection Program

The functions of the collection unit 71 and the saving unit 72 related to the collection process 7 are implemented by information processing executed by the processor 11 according to a collection program. The collection program is a type of an application program stored in the main memory 12 or the auxiliary storage device 13. A method for installing the collection program in the main memory 12 or the auxiliary storage device 13 is not particularly limited. The collection program can be installed in the main memory 12 or the auxiliary storage device 13 by recording the collection program in a removable recording medium or distributing the collection program via communication network 2. The recording medium may be in any format as long as the recording medium can store programs and is readable by devices, such as a CD-ROM or a memory card.

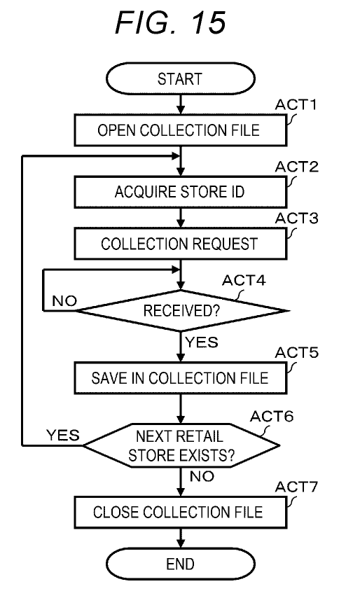

FIG. 15 is a flowchart of information processing executed by the processor 11 of the commodity master generation device 1 according to the collection program. For example, when a time recorded by the timepiece 14 reaches a predetermined time and the collection program is activated, the processor 11 starts the information processing of the procedure illustrated in the flowchart of FIG. 15.

First, in ACT1, the processor 11 opens the collection file 132. Next, in ACT2, the processor 11 acquires a store ID which is identification information of any retail store with a POS system 3 connected via the communication network 2.

After acquiring the store ID, the processor 11 proceeds to ACT3. In ACT3, the processor 11 outputs a collection request to the POS system 3 of the retail store identified by the store ID. The collection request is transmitted to the communication network 2 via the communication interface 15. The collection request includes the store ID acquired in ACT2.

When a POS server 32 in a POS system 3 connected to the communication network 2 receives the collection request matching its store ID, the POS server 32 transmits all the sales management data SMD saved in the sales management file 6 to the commodity master generation device 1. The POS server 32 then clears the sales management file 6.

In ACT4, the processor 11 of the commodity master generation device 1 waits for the sales management data SMD. When the sales management data SMD is received via the communication interface 15, the processor 11 proceeds to ACT5. In ACT5, the processor 11 saves all the received sales management data SMD in the collection file 132.

After saving the sales management data SMD, the processor 11 proceeds to ACT6. In ACT6, the processor 11 checks whether there is another retail store from which sales management data SMD is to be collected.

If there is still another retail store, the processor 11 returns to ACT2. The processor 11 acquires the store ID of the next retail store. Thereafter, the processor 11 executes the processing in ACT3 to ACT5 in the same manner as described above. Thus, the sales management data SMD collected from the sales management file 6 of each retail store is collectively saved in the collection file 132.

In ACT6, when there is no other retail store left from which the sales management data SMD is to be collected, the processor 11 proceeds to ACT7. In ACT7, the processor 11 closes the collection file 132. The processor 11 then ends the information processing according to the collection program.

The processor 11 implements the function of the collection unit 71 by the processing of ACT2 to ACT4. The processor 11 implements the function of the saving unit 72 by the processing of ACT5.

### Description of Generation Program

The functions of the acquisition unit 81, the classification unit 82, the selection unit 83, and the generation unit 84 related to the generation process 8 are implemented by the information processing executed by the processor 11 according to the generation program. The generation program is a type of the application program stored in the main memory 12 or the auxiliary storage device 13. A method for installing the generation program in the main memory 12 or the auxiliary storage device 13 is not particularly limited. The generation program can be installed in the main memory 12 or the auxiliary storage device 13 by recording the generation program in a removable recording medium or distributing the generation program through communication via the communication network 2. The recording medium may be in any format as long as the recording medium can store programs and is readable by devices, such as a CD-ROM or a memory card.

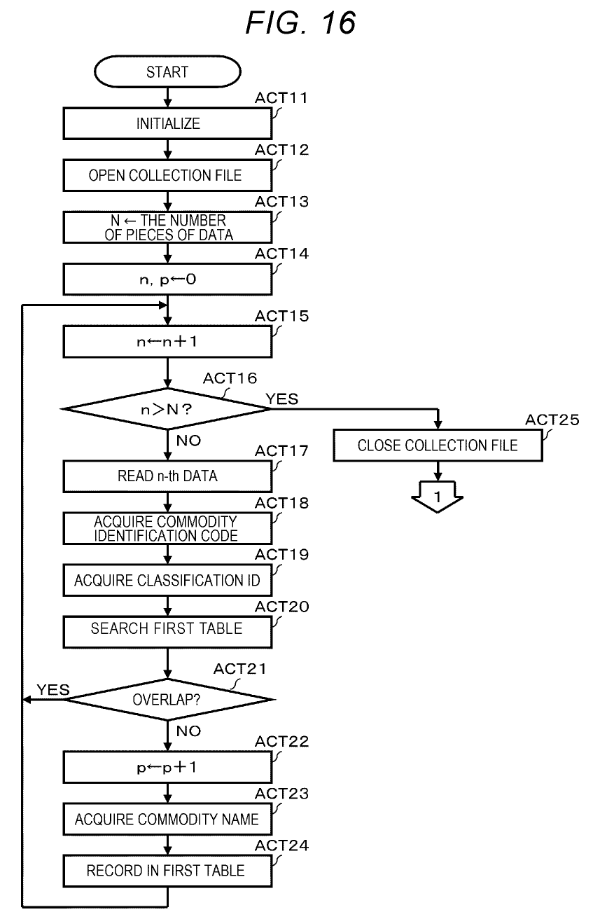

FIGS. 16 to 21 are flowcharts of information processing executed by the processor 11 of the commodity master generation device 1 according to the generation program. For example, when the execution of the generation process 8 is instructed by operation of the input device 161, the processor 11 starts the information processing illustrated in the flowchart of FIG. 16.

First, in ACT11, the processor 11 performs initialization. By this initialization, the data of the first table 121, the second table 122, the third table 123, the fourth table 124, and the fifth table 125 are cleared.

After finishing the initialization, the processor 11 proceeds to ACT12. In ACT12, the processor 11 opens the collection file 132. Next, in ACT13, the processor 11 sets the number of pieces of sales management data SMD saved in the collection file 132 into a register N. In ACT14, the processor 11 resets both a first counter n and a second counter p to "0". Thereafter, the processor 11 proceeds to ACT15. In ACT15, the processor 11 counts up the first counter n by "1". Then, in ACT16, the processor 11 checks whether the first counter n exceeds a value of the register N.

When the first counter n does not exceed the value of the register N, the processor 11 proceeds to ACT17. In ACT17, the processor 11 reads the n-th sales management data SMD from the collection file 132. The n-th value (value "n") is a current count value of the first counter n. That is, in the first processing of ACT17, the processor 11 reads the sales management data SMD saved first from the collection file 132.

After reading the sales management data SMD, the processor 11 proceeds to ACT18. In ACT18, the processor 11 acquires a commodity identification code from the sales management data SMD. In ACT19, the processor 11 acquires the first classification ID, the second classification ID, the third classification ID, and the fourth classification ID from the sales management data SMD. Thereafter, the processor 11 proceeds to ACT20. In ACT20, the processor 11 searches the first table 121 using the acquired data. In ACT21, the processor 11 determines whether data overlapping the just acquired data already exists in the first table 121.

When data already overlapping the acquired data does not exist in the first table 121, the processor 11 proceeds to ACT22. In ACT22, the processor 11 counts up the second counter p by "1". In ACT23, the processor 11 acquires a commodity name from the n-th sales management data SMD. Then, in ACT24, the processor 11 records the commodity identification code, the first classification ID, the second classification ID, the third classification ID, the fourth classification ID, and the commodity name in the respective columns of a row (table number) of the first table 121 with a value of "p". The row number (table number) is the current value of the second counter p when the respective row is generated in the table. Thereafter, the processor 11 returns to ACT15.

In ACT21, when data overlapping the just acquired data already exists in the first table 121, the processor 11 skips the processing of ACT22 to ACT24 and returns to ACT15.

Returning to ACT15, the processor 11 further counts up the first counter n by "1". Then, when the first counter n does not exceed the value of the register N, the processor 11 executes the processing after ACT17 in the same manner as described above. That is, the processor 11 reads the sales management data SMD saved second from the collection file 132, acquires the commodity identification code, the first classification ID, the second classification ID, the third classification ID, and the fourth classification ID from the sales management data SMD, and searches the first table 121. As a result, when the acquired data does not overlap with data already in the first table 121, the processor 11 executes the processing of ACT22 to ACT24. That is, the processor 11 counts up the second counter p, acquires a commodity name from the sales management data SMD, and records the commodity identification code, the first classification ID, the second classification ID, the third classification ID, the fourth classification ID, and the commodity name in the respective columns for the row (table number) of the first table 121 at "p". If the acquired data overlaps with data already in the first table 121, the processor 11 does not execute the processing of ACT22 to ACT24.

As described above, the processor 11 sequentially reads the sales management data SMD from the collection file 132, and executes the processing of ACT18 to ACT24 each time as appropriate. Thus, in the first table 121, a record in which a combination of the commodity identification code, the first classification ID, the second classification ID, the third classification ID, and the fourth classification ID is unique is sequentially saved together with the commodity name. Hereinafter, a record in a row of the first table 121 is referred to as a first table record.

When the last sales management data SMD saved in the collection file 132 is read and the processing of ACT18 to ACT24 is executed, the first counter n exceeds the value of the register N in ACT16. When the first counter n exceeds the value of the register N, the processor 11 proceeds to ACT25. In ACT25, the processor 11 closes the collection file 132.

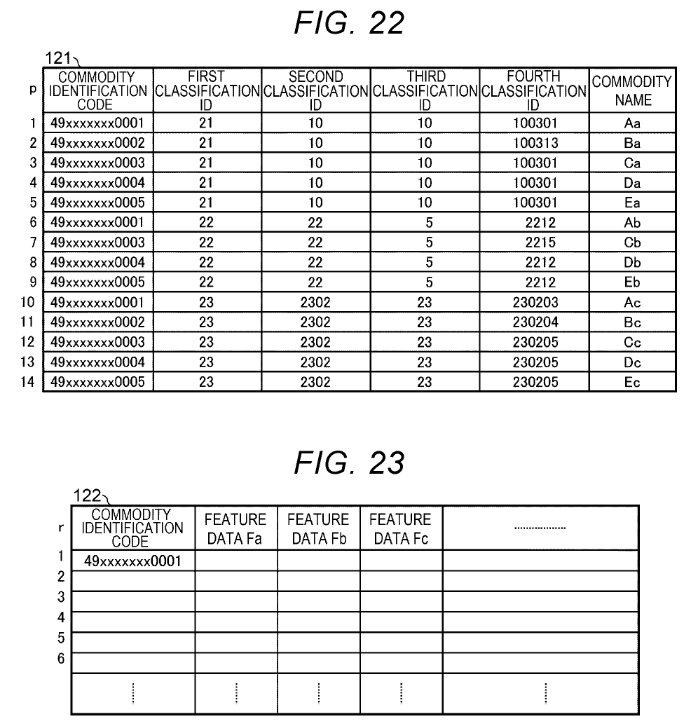

FIG. 22 illustrates an example of data recorded in the first table 121 when the processing of ACT25 in FIG. 16 is executed and the collection file 132 is closed. As illustrated in FIG. 22, in the first table 121, the first table records (including a commodity identification code, a first classification ID, a second classification ID, a third classification ID, a fourth classification ID, and a commodity name) are recorded in the order of table numbers (row numbers) p. In each first table record, the combination of the commodity identification code, the first classification ID, the second classification ID, the third classification ID, and the fourth classification ID is unique (does not overlap with any other row). That is, the sales management data SMD in which the combination of the commodity identification code the first classification ID, the second classification ID, the third classification ID, and the fourth classification ID is unique is extracted from the collection file 132, and the first table records generated based on the sales management data SMD are recorded in the first table 121.

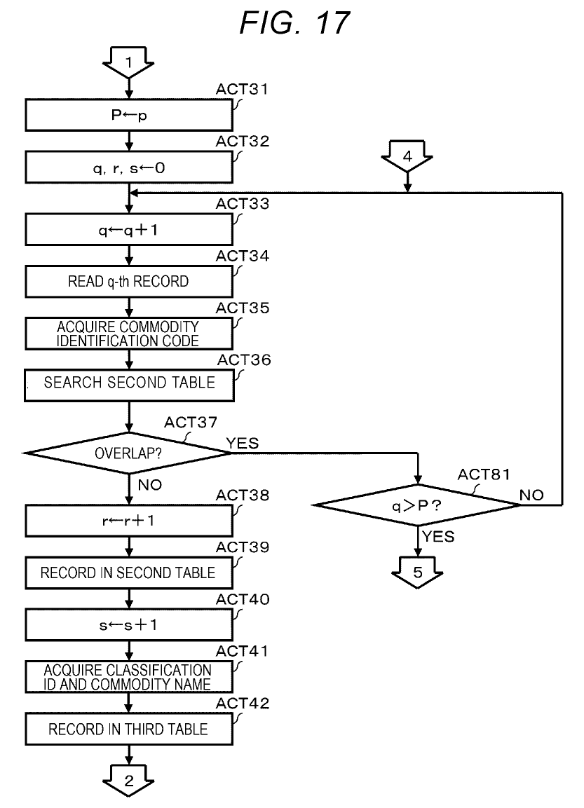

In ACT25 of FIG. 16, the processor 11 closes the collection file 132 then proceeds to ACT31 of FIG. 17. In ACT31, the processor 11 sets the value of the second counter p into a register P. In ACT32, the processor 11 resets the third counter q, the fourth counter r, and the fifth counter s to "0". The value of the second counter p is the number of the first table records saved in the first table 121.

After resetting the third counter q, the fourth counter r, and the fifth counter s, the processor 11 proceeds to ACT33. In ACT33, the processor 11 counts up the third counter q by "1". Then, in ACT34, the processor 11 reads the first table record at table number (row number) "q" from the first table 121. The table number "q" matches a current value of the third counter q.

After reading the first table record, the processor 11 proceeds to ACT35. In ACT35, the processor 11 acquires a commodity identification code from the first table record. Then, in ACT36, the processor 11 searches the second table 122 for the acquired commodity identification code. In ACT37, the processor 11 determines whether a commodity identification code overlapping the acquired commodity identification code already exists in the second table 122.

When the acquired commodity identification code does not overlap with data already in the second table 122, the processor 11 proceeds to ACT38. In ACT38, the processor 11 counts up the fourth counter r by "1". Then, in ACT39, the processor 11 records the commodity identification code acquired from the first table record in the second table 122 at row number "r". The row (table) number "r" is a current value of the fourth counter r.

FIG. 23 illustrates an example of data recorded in the second table 122 when the processing of ACT39 in FIG. 17 is executed for the first time. As illustrated in FIG. 23, in ACT34, since the first table record at row p equal to "1" is read as the q-th first table record, the commodity identification code "49xxxxxx0001" of the first table record (at row p = 1) is recorded in the second table 122 at row r = 1.

In ACT39 of FIG. 17, the processor 11 records the commodity identification code in the second table 122 and proceeds to ACT40. In ACT40, the processor 11 counts up the fifth counter s by "1". In ACT41, the processor 11 acquires the first classification ID, the second classification ID, the third classification ID, and the commodity name from the first table record. Then, in ACT42, the processor 11 records the commodity identification code, the first classification ID, the second classification ID, the third classification ID, and the commodity name acquired from the first table record in a row (table) number of the third table 123 at "s", the current value of the fifth counter s.

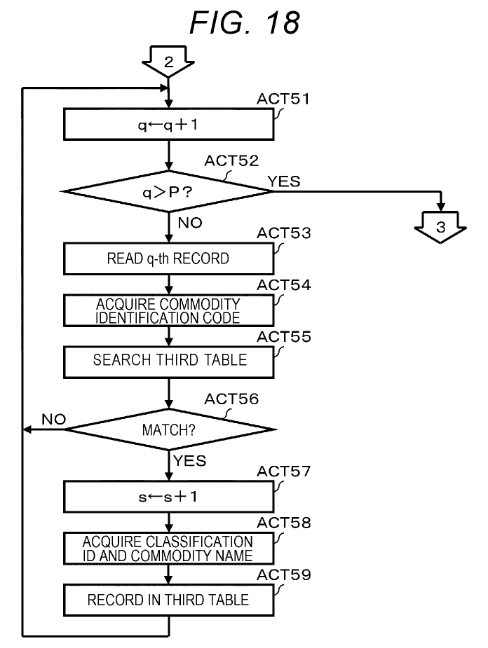

After recording the commodity identification code, the first classification ID, the second classification ID, the third classification ID, and the commodity name in the third table 123, the processor 11 proceeds to ACT51 in FIG. 18. In ACT51, the processor 11 further counts up the third counter q by "1". Then, in ACT52, the processor 11 checks whether the third counter q exceeds a value of the register P.

When the third counter q does not exceed the value of the register P, the processor 11 proceeds to ACT53. In ACT53, the processor 11 reads the first table record at row (table) number "q" from the first table 121. After reading the first table record, the processor 11 proceeds to ACT54. In ACT54, the processor 11 acquires a commodity identification code from the first table record. Then, in ACT55, the processor 11 searches the third table 123 for the acquired commodity identification code. In ACT56, the processor 11 determines whether the acquired commodity identification code matches a commodity identification code already recorded at row "1" of the third table 123. If the commodity identification codes do not match, the processor 11 returns to ACT51 to search the next row.

On the other hand, if the commodity identification codes match, the processor 11 proceeds to ACT57. In ACT57, the processor 11 counts up the fifth counter s by "1". In ACT58, the processor 11 acquires the first classification ID, the second classification ID, the third classification ID, and the commodity name from the first table record. Then, in ACT59, the processor 11 records the commodity identification code, the first classification ID, the second classification ID, the third classification ID, and the commodity name acquired from the first table record in row "s" of the third table 123, that is, the row number is 2 or more. Thereafter, the processor 11 returns to ACT51.

Returning to ACT51, the processor 11 further counts up the third counter q. When the third counter q does not exceed the value of the register P, the processor 11 executes the processing of ACT53 to ACT59 in the same manner as described above. That is, the processor 11 reads the first table record at row "q" from the first table 121, and acquires a commodity identification code from the first table record. Then, the processor 11 executes the processing of ACT57 to ACT59 only when the commodity identification code matches a commodity identification code already recorded in a row "1" of the third table 123. That is, the processor 11 counts up the fifth counter s by "1", and records the commodity identification code, the first classification ID, the second classification ID, the third classification ID, and the commodity name acquired from the first table record in the third table 123 at row "s".

The processor 11 repeatedly executes the processing of ACT53 to ACT59 until the third counter q exceeds the value of the register P. Thus, the commodity identification code, the first classification ID, the second classification ID, the third classification ID, and the commodity name of all the first table records including the commodity identification code recorded in a row r of the second table 122 are recorded in the third table 123 in ACT39 of FIG. 17. Hereinafter, a record saved in a row in the third table 123 is referred to as a third table record.

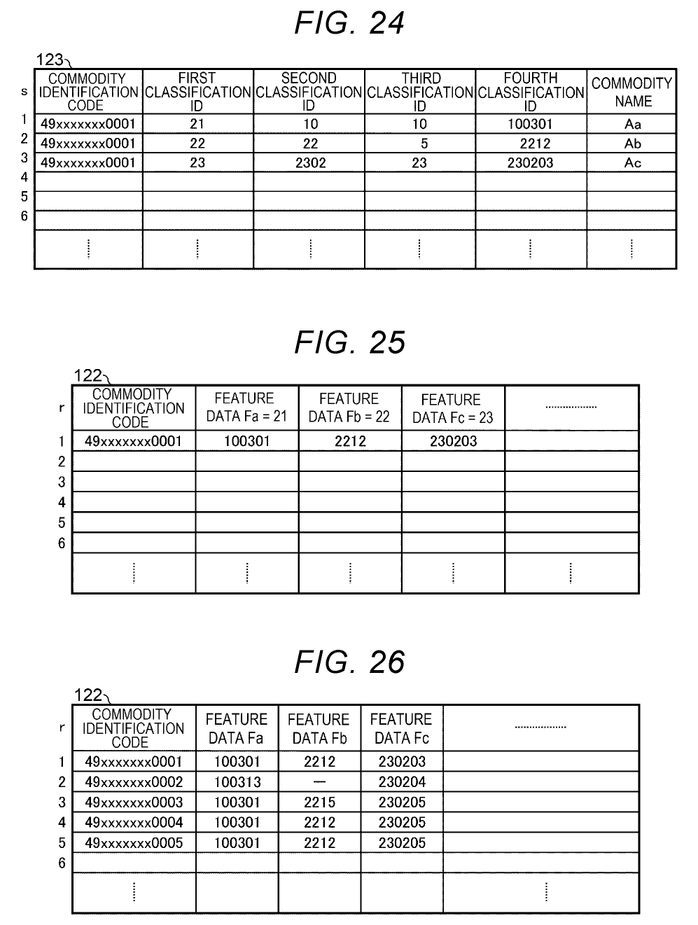

FIG. 24 illustrates an example of data recorded in the third table 123 when the third counter q exceeds the value of the register P in ACT52 of FIG. 18. As illustrated in FIG. 23, in the third table 123, first table records including the commodity identification code "49xxxxxx0001" are at row p equal to "1",

"6", and "10". The values in these first table records are then recorded in different rows (row s “1” through “3”) in the third table 123.

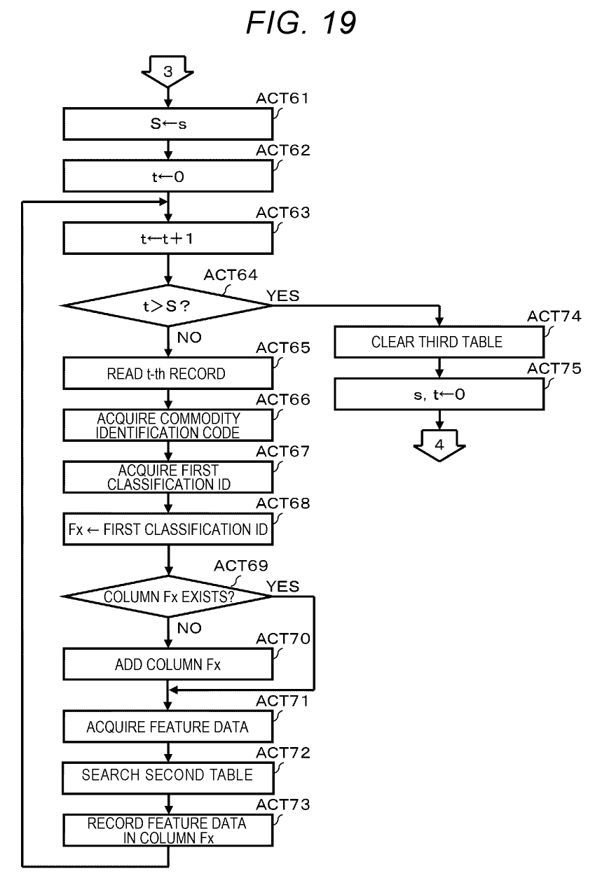

In ACT52 of FIG. 18, when the third counter q exceeds the value of the register P, the processor 11 proceeds to ACT61 in FIG. 19. In ACT61, the processor 11 sets the value of the fifth counter s into a register S. In ACT62, the processor 11 resets a sixth counter t to "0". The value of the fifth counter s is the number of the third table records saved in the third table 123.

After resetting the sixth counter t, the processor 11 proceeds to ACT63. In ACT63, the processor 11 counts up the sixth counter t by "1". Then, in ACT64, the processor 11 checks whether the sixth counter t exceeds a value of the register S.

When the sixth counter t does not exceed the value of the register S, the processor 11 proceeds to ACT65. In ACT65, the processor 11 reads the third table record at row "t" from the third table 123. The row number "t" is the current value of the sixth counter t.

After reading the third table record, the processor 11 proceeds to ACT66. In ACT66, the processor 11 acquires a commodity identification code from the third table record. In ACT67, the processor 11 acquires, from the third table record, the first classification ID that can be feature data identification information of the second table 122. Then, in ACT68, the processor 11 sets the first classification ID into a register Fx.

After setting the first classification ID into the register Fx, the processor 11 proceeds to ACT69. In ACT69, the processor 11 determines whether a column having a value of the register Fx as the feature data identification information exists in columns other than the commodity identification code in the second table 122. When there is no corresponding column in the second table 122, the processor 11 proceeds to ACT70. In ACT70, the processor 11 adds, to the second table 122, a column having the value of the register Fx as the feature data identification information. On the other hand, when there is no corresponding column in the second table 122, the processor 11 skips the processing of ACT70.

After executing or skipping the processing of ACT70, the processor 11 proceeds to ACT71. In ACT71, the processor 11 acquires, from the third table record, the first item that can be feature data in the cluster analysis, for example, the fourth classification ID. Next, the processor 11 proceeds to ACT72. In ACT72, the processor 11 searches the second table 122 for the commodity identification code acquired from the third table record. Then, in ACT73, the processor 11 records the fourth classification ID acquired as the feature data in the column having the value of the register Fx as the feature data identification information of the feature data identification information Fa, Fb, Fc, ... of the table (row) number in which the same commodity identification code is recorded.

After recording the fourth classification ID in the column having the value of the register Fx as the feature data identification information, the processor 11 returns to ACT63. The processor 11 further counts up the sixth counter t by "1". When the sixth counter t does not exceed the value of the register S, the processor 11 executes the processing of ACT65 to ACT73 in the same manner as described above. That is, the processor 11 reads the third table record at row "t" from the third table 123, and acquires a commodity identification code from the third table record. The processor 11 acquires the first classification ID from the third table record, and sets the first classification ID in the register Fx. When a column having the value of the register Fx does not exist among the columns in the second table 122, the processor 11 adds, to the second table 122, the column having the value of the register Fx as the feature data identification information. Thereafter, the processor 11 acquires the fourth classification ID from the third table record, and records the fourth classification ID in the column of the second table 122 having the value of the register Fx as the feature data identification information.

The processor 11 repeatedly executes the processing of ACT65 to ACT73 until the sixth counter t exceeds the value of the register S. Thus, in the second table 122, the fourth classification ID of each third table record is recorded for feature data identification information in association with any shared commodity identification code in the third table records. Specifically, the fourth classification ID of the third table record is recorded in the column in which the first classification ID of the third table record is set as the feature data identification information.

FIG. 25 illustrates an example of data recorded in the second table 122 when the sixth counter t exceeds the value of the register S in ACT64 of FIG. 19. As illustrated in FIG. 25, in the second table 122, a column having the first classification ID of "21" is added as a column of the feature data identification information Fa, a column having the first classification ID of "22" is added as a column of the feature data identification information Fb, and a column having the first classification ID of "23" is added as a column of the feature data identification information Fc. Then, the fourth classification ID "100301" of the third table record at row s equal "1" is recorded in the column of the feature data identification information Fa having the same row number for which the commodity identification code "49xxxxxx0001" is recorded. The fourth classification ID "2212" of the third table record at row number s "2" is recorded in the feature data identification information Fb. The fourth classification ID "230203" of the third table record at row number s "3" is recorded in the feature data identification information Fc.

In ACT64, when the sixth counter t exceeds the value of the register S, the processor 11 proceeds to ACT74. In ACT74, the processor 11 clears the third table 123. In ACT75, the processor 11 resets the fifth counter s and the sixth counter t. Thereafter, the processor 11 proceeds to ACT33 in FIG. 17. The processor 11 executes the processing in ACT33 and subsequent ACTs in the same manner as described above. That is, the processor 11 further counts up the third counter q by "1", and reads the first table record whose row number is "q" from the first table 121. The processor 11 acquires a commodity identification code from the first table record, searches the second table 122, and determines whether a commodity identification code overlapping the acquired commodity identification code exists in the second table 122.

Here, when a commodity identification code overlapping the acquired commodity identification code already exists in the second table 122, the processor 11 proceeds to ACT81. In ACT81, the processor 11 checks whether the third counter q exceeds the value of the register P. When the third counter q does not exceed the value of the register P, the processor 11 returns to ACT33 and executes the processing of ACT33 to ACT37 again.

As described above, the processor 11 sequentially reads the first table records from the first table 121. When the first table record including the commodity identification code not recorded in the second table 122 is acquired, the processor 11 executes the processing of ACT38 to ACT42 in FIG. 17, the processing of ACT51 to ACT59 in FIG. 18, and the processing of ACT61 to ACT75 in FIG. 19. Thus, in the second table 122, for each commodity identification code of each sales management data SND, the fourth classification ID of the sales management data SMD is recorded for each feature data identification information, that is, for each first classification ID. Hereinafter, a record in a row of second table 122 is referred to as a second table record.

When all the commodity identification codes of the first table record are recorded in the second table 122, the third counter q exceeds the value of the register P in ACT81.

FIG. 26 illustrates an example of data recorded in the second table 122 when the third counter q exceeds the value of the register P in ACT81 of FIG. 17. As illustrated in FIG. 26, the commodity identification code "49xxxxxx0002" of the first table record at row p 2 in the first table 121 is "2" is recorded in row r "2" in the second table 122. The fourth classification ID "100313" of the first table record at row p "2" is recorded as the feature data identification information Fa at row r "2", and the fourth classification ID "230204" of the first table record at row p "11" is recorded as the feature data identification information Fc. A fourth classification ID is not recorded as the feature data identification information Fb in this example.

The commodity identification code "49xxxxxx0003" of the first table record of the first table 121 at row p "3" is recorded in the commodity identification code column at row r "3" of the second table 122. The fourth classification ID "100301" of the first table record at row p "3" is recorded as the feature data identification information Fa at row r "3", the fourth classification ID "2215" of the first table record at row p "7" is recorded as the feature data identification information Fb, and the fourth classification ID "230205" of the first table record at row p "12" is recorded as the feature data identification information Fc.

The commodity identification code "49xxxxxx0004" of the first table record at row p "4" of the first table 121 is recorded in the commodity identification code column at row r "4" in the second table 122. The fourth classification ID "100301" of the first table record at row p "4" is recorded as the feature data identification information Fa at row r "4", the fourth classification ID "2212" of the first table record at row p "8" is recorded as the feature data identification information Fb, and the fourth classification ID "230205" of the first table record at row p "13" is recorded in as the feature data identification information Fc.

The commodity identification code "49xxxxxx0005" of the first table record at row p "5" in the first table 121 is recorded in the commodity identification code column at row r "5" in the second table 122. The fourth classification ID "100301" of the first table record at row p "5" is recorded as the feature data identification information Fa at row 4 "5", the fourth classification ID "2212" of the first table record at row p "9" is recorded as the feature data identification information Fb, and the fourth classification ID "230205" of the first table record at row p "14" is recorded as the feature data identification information Fc.

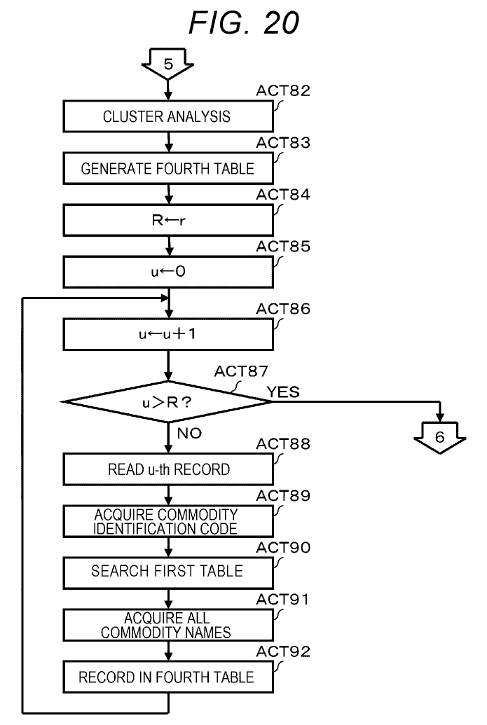

In ACT81 of FIG. 17, when the third counter q exceeds the value of the register P, the processor 11 proceeds to ACT82 in FIG. 20. In ACT82, the processor 11 performs cluster analysis on the data of the second table 122 by an unsupervised clustering method. For example, the processor 11 sets the fourth classification ID recorded in the column of the feature data identification information Fa in the second table 122 as the feature data, and classifies commodity identification codes having similar feature data as one group into two or more groups. Then, the processor 11 assigns a class number to each classification.

After finishing the cluster analysis, the processor 11 proceeds to ACT83. In ACT83, the processor 11 generates the fourth table 124. That is, the processor 11 records, in a commodity identification information column in the fourth table 124, the commodity identification code recorded in the second table 122. Further, the processor 11 records, in the class number column in the fourth table 124, a class number assigned to a classification of a group to which the commodity identification code at the same row belongs. Hereinafter, a record saved in a row of the fourth table 124 is referred to as a fourth table record.

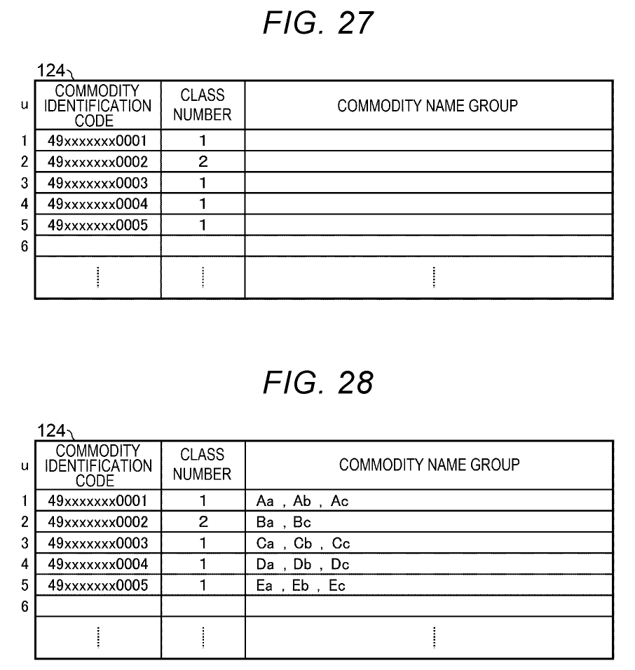

FIG. 27 illustrates data of the fourth table 124 generated as a result obtained by performing cluster analysis on the fourth classification ID recorded in the column of the feature data identification information Fa in the second table 122 illustrated in FIG. 26 in ACT82 and ACT83 of FIG. 20. When the cluster analysis is performed on the fourth classification ID recorded in the feature data identification information Fa column, since the fourth classification ID recorded in the feature data identification information Fa at row r "1", "3", "4", and "5" is the same, the commodity identification codes "49xxxxxx0001", "49xxxxxx0003", "49xxxxxx0004", and "49xxxxxx0005" become one group (class), and the class number "1" is assigned. On the other hand, the feature data identification information Fa at row "2" does not match that in the other rows r, the commodity identification code "49xxxxxx0002" becomes another group (class), and the class number "2" is assigned.

In ACT83 of FIG. 20, the processor 11 generates the fourth table 124 then proceeds to ACT84. In ACT84, the processor 11 sets the value of the fourth counter r in the register R. In ACT85, the processor 11 resets a seventh counter u to "0". The value of the fourth counter r is the number of the fourth table records saved in the fourth table 124.

After resetting the seventh counter u, the processor 11 proceeds to ACT86. In ACT86, the processor 11 counts up the seventh counter u by "1". Then, in ACT87, the processor 11 checks whether the seventh counter u exceeds the value of the register R.

When the seventh counter u does not exceed the value of the register R, the processor 11 proceeds to ACT88. In ACT88, the processor 11 reads the fourth table record having the table number "u" from the fourth table 124. After reading the fourth table record, the processor 11 proceeds to ACT89. In ACT89, the processor 11 acquires a commodity identification code from the fourth table record.

After acquiring the commodity identification code, the processor 11 proceeds to ACT90. In ACT90, the processor 11 searches the first table 121. Then, in ACT91, the processor 11 extracts all the first table records including the commodity identification code acquired in ACT89 from the first table 121, and collectively acquires text data of commodity names from these extracted first table records. In ACT92, the processor 11 records the text data of all the commodity names acquired in ACT91 in a commodity name group column corresponding to the row "u" of the fourth table 124.

Thereafter, the processor 11 returns to ACT86. The processor 11 executes the processing in ACT86 and subsequent ACTs in the same manner as described above. That is, the processor 11 sequentially reads the fourth table records from the fourth table 124, acquires the text data of all the commodity names from the first table records including the commodity identification codes of the fourth table records, and records the text data in the commodity name group column of the fourth table 124. When all the fourth table records are read from the fourth table 124, the seventh counter u exceeds the value of the register R.

FIG. 28 is an example of data recorded in the fourth table 124 when the seventh counter u exceeds the value of the register R in ACT87 of FIG. 20. As illustrated in FIG. 28, commodity names "Aa", "Ab", and "Ac" in first table records with the commodity identification code "49xxxxxx0001" are recorded in the commodity name group column at row u "1" in the fourth table 124. Commodity names "Ba" and "Bc" of in first table records with the commodity identification code "49xxxxxx0002" are recorded in the commodity name group column at row u "2". Commodity names "Ca", "Cb", and "Cc" in the first table records with the commodity identification code "49xxxxxx0003" are recorded in the commodity name group column at row u "3". Commodity names "Da", "Db", and "Dc" in the first table records with the commodity identification code "49xxxxxx0004" are recorded in the commodity name group column at row u "4". Commodity names "Ea", "Eb", and "Ec" in the first table records with the commodity identification code "49xxxxxx0005" are recorded in the commodity name group column at row u "5".

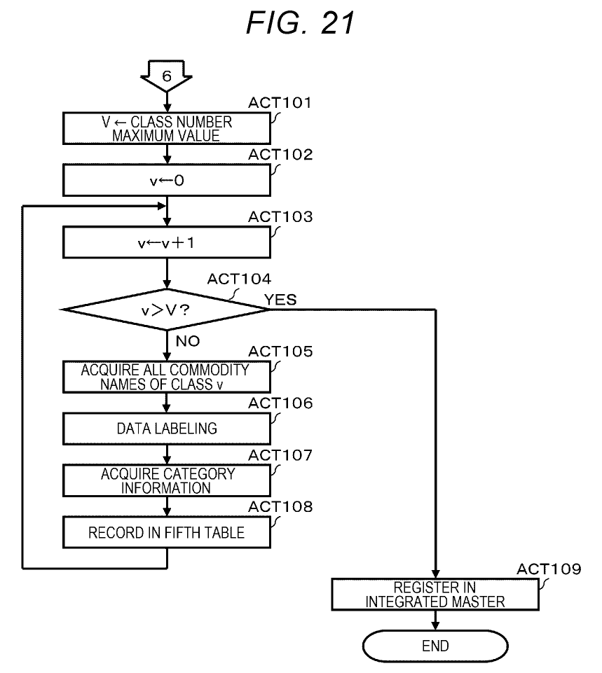

In ACT87 of FIG. 20, when the seventh counter u exceeds the value of the register R, the processor 11 proceeds to ACT101 of FIG. 21. In ACT101, the processor 11 sets a maximum value of the class number into a register V. In ACT102, the processor 11 resets an eighth counter v to "0". Next, in ACT103, the processor 11 counts up the eighth counter v by "1". Then, in ACT104, the processor 11 checks whether the eighth counter v exceeds a value of the register V.

When the eighth counter v does not exceed the value of the register V, the processor 11 proceeds to ACT105. In ACT105, the processor 11 searches the fourth table 124, and acquires, from the fourth table record to which "v" is assigned as the class number, text data of all commodity names recorded in the commodity name group column.

After acquiring the text data of the commodity names, the processor 11 proceeds to ACT106. In ACT106, the processor 11 performs data labeling. That is, the processor 11 inputs the text data of the commodity names to the large-scale language model (LLM), and causes the generative AI to select category information serving as an appropriate label for the commodity name from the category master 131.

In ACT107, the processor 11 acquires the category information selected by the data labeling, that is, the first classification ID, the second classification ID, the third classification ID, and the classification code for uniquely identifying the combination thereof. After acquiring the category information, the processor 11 proceeds to ACT108. In ACT108, the processor 11 records the category information in the fifth table 125. Specifically, the processor 11 sequentially records, in the commodity identification code column of the fifth table 125, the commodity identification code of the fourth table record to which "v" is assigned as the class number, and further records the classification code, the first classification ID, the second classification ID, and the third classification ID of the category information acquired in ACT107 into respective columns of a classification code, a first classification ID, a second classification ID, and a third classification ID corresponding to a column in which a commodity identification code is recorded.

After recording the category information in the fifth table 125, the processor 11 returns to ACT103. The processor 11 further counts up the eighth counter v by "1". When the eighth counter v does not exceed the value of the register V, the processor 11 executes the processing of ACT105 to ACT108 in the same manner as described above. That is, the processor 11 acquires text data of all commodity names recorded in the commodity name group column from the fourth table record to which "v" is assigned as the class number, and performs data labeling by inputting the text data to the large-scale language model. Then, the processor 11 records the category information selected by the data labeling in the fifth table 125. Thus, in the fifth table 125, the category information of the classification code, the first classification ID, the second classification ID, and the third classification ID is recorded in association with the commodity identification code to which the class number is assigned by the cluster analysis.

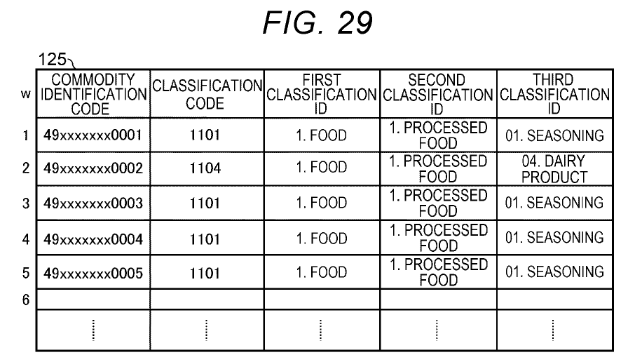

FIG. 29 illustrates an example of data recorded in the fifth table 125 when the eighth counter v exceeds the value of the register V in ACT104 of FIG. 21. As in the fourth table 124 illustrated in FIG. 28, when the class number "1" is assigned to the commodity identification codes "49xxxxxx0001", "49xxxxxx0003", "49xxxxxx0004", and "49xxxxxx0005", the text data of the commodity names "Aa", "Ab", "Ac", "Ca", "Cb", "Cc", "Da", "Db", "Dc", "Ea", "Eb", and "Ec" used with these commodity identification codes is input to the large-scale language model, and the data labeling is performed. As a result, when the classification code "1101" in the category master 131 is selected in the fifth table 125, a first classification ID "1. foods", a second classification ID "1. processed foods", and a third classification ID "01. seasoning" are recorded in association with each of the corresponding commodity identification codes.

When the class number "2" is assigned to the commodity identification code "49xxxxxx0002", the text data of the commodity names "Ba" and "Bc" used with this commodity identification code is input to the large-scale language model, and the data labeling is performed. As a result, when the classification code "1104" in the category master 131 is selected in the fifth table 125, a first classification ID "1. foods", a second classification ID "1. processed foods", and a third classification ID "04. dairy product" are recorded in association with the corresponding commodity identification code.

In ACT104 of FIG. 21, when the eighth counter v exceeds the value of the register V, the processor 11 proceeds to ACT109. In ACT109, the processor 11 registers the data of the fifth table 125 in the integrated master 5. The processor 11 then ends the information processing according to the generation program.

The processor 11 implements a function as the acquisition unit 81 by the processing of ACT65 to ACT73 in FIG. 19. The processor 11 implements a function as the classification unit 82 by the processing of ACT82 and ACT83 in FIG. 20. The processor 11 implements a function as the selection unit 83 by the processing of ACT105 to ACT107 in FIG. 21. The processor 11 implements a function as the generation unit 84 by the processing of ACT108 and ACT109 in FIG. 21.

### Description of Operation and Effect of Commodity Master Generation Device

As described above, the commodity master generation device 1 collects, by an operation of the collection process 7 having the functions as the collection unit 71 and the saving unit 72, the sales management data SMD from two or more retail stores including a retail master 4 whose category information is not unified. The commodity master generation device 1 automatically generates the integrated master 5 using the collected sales management data SMD by an operation of the generation process 8 having the functions of the acquisition unit 81, the classification unit 82, the selection unit 83, and the generation unit 84.

The integrated master 5 generated in this way is a database for managing the category information of the various commodities identified by commodity identification codes. In the integrated master 5, the category information is managed in association with a commodity identification code, and thus, for example, when the analysis service business entity collects data of all the commodities sold in each retail store to be analyzed, the integrated master 5 can be referred to as it includes data with category information unified across the different retail stores. That is, when retail stores adopt different categorizations of a product having the same commodity identification code, the integrated master 5 provides a standardized or adjusted categorization for a commodity across the different retail stores. Therefore, since the work required for unifying category information of the sales management data SMD collected from each retail store becomes unnecessary, it is possible to efficiently analyze the data.

### Other Embodiments

Although an embodiment of a commodity master generation device capable of efficiently generating a commodity master with unified category labels or the like from data collected from a plurality of retail stores has been described above, the present disclosure is not limited thereto.

In an embodiment, a commodity name, a manufacturer name, a unit price, a first classification ID, a second classification ID, a third classification ID, and a fourth classification ID are exemplified as the information necessary for the sales management that is acquired by the search unit 322 from the commodity records PMD. The information necessary for the sales management is not limited thereto. For example, additional attribute information (such as a first attribute, a second attribute, and a third attribute) may be included. In some examples, less than the described information may be collected. For example, the fourth classification ID may be excluded.

Levels of the categorization are not limited to the four levels described such as the first classification (major classification), the second classification (medium classification), the third classification (small classification), and the fourth classification (fine classification). Additional levels or fewer levels may be adopted.

The information unified by the integrated master 5 is not limited to category information. For example, when different commodity names are set for the same commodity in each retail store, the commodity names can be unified by replacing the category information of an embodiment with commodity name information.

The first commodity master and the second commodity master are not limited to being a retail (store-level) master. For example, a head office master managed by a retail head office covering, for example, multiple stores or a geographic region, a wholesale (wholesale-level) master managed by a wholesaler, or a manufacturer master managed by a manufacturer may be used as the first commodity master and the second commodity master in other examples.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A commodity master generation device, comprising:
a communication interface connectable to a plurality of point-of-sale systems of different stores;
a storage unit for storing sales management data from the plurality of point-of-sale systems; and
a processor configured to:
acquire first sales management data generated by a first point-of-sale system using a first commodity master in which a first commodity code is associated with first feature data and second sales management data generated by a second point-of-sale system using a second commodity master in which the first commodity code is associated with second feature data;
determine a classification grouping for the first commodity code based on similarity of the first and second feature data to feature data associated with a second commodity code associated with the classification grouping;
select category information to be used with the first commodity code from predefined category information based on the determined classification grouping; and
generate a third commodity master in which the selected category information is used in association with the first commodity code.

2. The commodity master generation device according to claim 1, wherein
the first sales management data includes classification IDs on a plurality of levels for each commodity code in the first commodity master,
the second sales management data includes classification IDs on a plurality of levels for each commodity in the second commodity master, and
the first feature data is a classification ID of one level among the plurality of levels.

3. The commodity master generation device according to claim 1, wherein the classification grouping is determined by an unsupervised clustering method using the first feature data.

4. The commodity master generation device according to claim 1, wherein
the first feature data is a commodity name, and
category information is selected from the predefined category information by inputting commodity names of commodities in the determined classification grouping to a large-scale language model.

5. The commodity master generation device according to claim 1, wherein the processor is further configured to:
collect the first sales management data and the second sales management data respectively from the first point-of-sale system and the second point-of-sale system.

6. A sales data analysis service system for a plurality of different retail stores, comprising:
a plurality of point-of-sale systems for different stores; and
a commodity master generation device including:
a communication interface connectable to the plurality of point-of-sale systems across a network;
a storage unit for storing sales management data from the plurality of point-of-sale systems; and
a processor configured to:
acquire first sales management data generated by a first point-of-sale system of the plurality of point-of-sale systems that uses a first commodity master in which a first commodity code is associated with first feature data and second sales management data generated by second point-of-sale system of the plurality of point-of-sale systems that uses a second commodity master in which the first commodity code is associated with second feature data;
determine a classification grouping for the first commodity code based on similarity of the first and second feature data to feature data associated with a second commodity code associated with the classification grouping;
select category information to be used with the first commodity code from predefined category information based on the determined classification grouping; and
generate a third commodity master in which the selected category information is used in association with the first commodity code.

7. The sales data analysis service system according to claim 6, wherein
the first sales management data includes classification IDs on a plurality of levels for each commodity code in the first commodity master,
the second sales management data includes classification IDs on a plurality of levels for each commodity in the second commodity master, and
the first feature data is a classification ID of one level among the plurality of levels.

8. The sales data analysis service system according to claim 6, wherein the classification grouping is determined by an unsupervised clustering method using the first feature data.

9. The sales data analysis service system according to claim 6, wherein
the first feature data is a commodity name, and
category information is selected from the predefined category information by inputting commodity names of commodities in the determined classification grouping to a large-scale language model.

10. The sales data analysis service system according to claim 6, wherein the processor is further configured to:
collect the first sales management data and the second sales management data respectively from the first point-of-sale system and the second point-of-sale system.

11. A commodity master generation method, comprising:
acquiring first sales management data generated by a first point-of-sale system using a first commodity master in which a first commodity code is associated with first feature data and second sales management data generated by a second point-of-sale system using a second commodity master in which the first commodity code is associated with second feature data;
determining a classification grouping for the first commodity code based on similarity of the first and second feature data to feature data associated with a second commodity code associated with the classification grouping;
selecting category information to be used with the first commodity code from predefined category information based on the determined classification grouping;
generating a third commodity master in which the selected category information is used in association with the first commodity code; and
storing the third commodity master in a storage unit of a commodity master generation device.

12. The commodity master generation method according to claim 11, wherein
the first sales management data includes classification IDs on a plurality of levels for each commodity code in the first commodity master,
the second sales management data includes classification IDs on a plurality of levels for each commodity in the second commodity master, and
the first feature data is a classification ID of one level among the plurality of levels.

13. The commodity master generation method according to claim 11, wherein the classification grouping is determined by an unsupervised clustering method using the first feature data.

14. The commodity master generation method according to claim 11, wherein
the first feature data is a commodity name, and
category information is selected from the predefined category information by inputting commodity names of commodities in the determined classification grouping to a large-scale language model.

15. The commodity master generation method according to claim 11, further comprising:
collecting the first sales management data and the second sales management data respectively from the first point-of-sale system and the second point-of-sale system.
